(19) United States
(12) Patent Application Publication
(10) Pub. No.: US 2023/0258016 A1
(43) Pub. Date: Aug. 17, 2023

(54) CONVEYING DEVICE FOR MOVING VEHICLES, AND ROBOT SYSTEM COMPRISING SUCH A DEVICE

(71) Applicant: STRADOT SOCIÉTÉ PAR ACTIONS SIMPLIFIÉE À ASSOCIÉ UNIQUE ET CAPITAL VARIABLE, POMPERTUZAT (FR)

(72) Inventor: José IRIARTE, POMPERTUZAT (FR)

(21) Appl. No.: 17/627,766

(22) PCT Filed: Jul. 20, 2020
(86) PCT No.: PCT/FR2020/000207

§ 371 Date: Jul. 27, 2022

(30) Foreign Application Priority Data
Jul. 18, 2019 (FR) FR1908098
May 7, 2020 (FR) FR2004554

(51) Int. Cl. E04H 6/42; B66F 7/28; B66F 7/02; B66F 7/06

(52) U.S. Cl. CPC E04H 6/424; B66F 7/28; B66F 7/02; B66F 7/0666; B66F 2700/03; B66F 2700/04

(57) ABSTRACT

A conveying device (3; 3a; . . . ; 3i) for moving and parking vehicles (2), the conveying device (3) being movable and comprising at least one vehicle gripping means (8) configured to be movable between a gripping position wherein the gripping means (8) extends at least partially below the vehicle (2), and a release position wherein the gripping means (8) does not extend below the vehicle (2), the gripping means (8) being configured to support the weight of the vehicle (2), the device being characterized in that it comprises at least one computer which is associated with sensors (8d) and configured to control the movement of the conveying device (3; 3a; . . . ; 3i) and the gripping means (8). The invention also relates to a robot system and a corresponding program.

The invention relates to the field of managing the parking of vehicles, in particular of motor vehicles such as cars. The invention relates more particularly to a conveying device for moving and parking vehicles, allowing an increase in the number of parked vehicles per unit area, as well as an increase in the speed of parking operations.

In particular, but not exclusively, the present invention is intended for the automatic or semi-automatic parking of motor vehicles.

In this field, users conventionally arrive in a vehicle parking area with several parking spaces. The user or a driver must then drive through the entire parking area until they find a parking space.

This conventional solution does not give full satisfaction because it consumes time and generates fatigue for the driver. In addition, it requires access routes at ground level, defined in advance or created transiently during the operations of parking or retrieving a vehicle in a compact parking lot.

This need for access roads implies a reduction in the effective speed of parking operations because several movements or intermediate maneuvers of vehicles are generally necessary to park or search for a specific vehicle in a compact parking lot.

In addition, this implies a reduction in the number of parking spaces available, or in the average density of the parking lot in view of the area required by the access roads and/or areas for intermediate maneuvers.

These drawbacks have made so-called automatic or robot parking systems less applicable for parking lots with high demand during rush hour, as is the case with businesses, park and ride facilities, and shopping centers. Furthermore, it is preferable that such a system be movable so that it can be used on existing parking areas, which has not been the major focus of development in this area.

The U.S. Pat. No. 2,904,200 proposes a device for moving and parking which is of some interest, however, this device is not fully satisfactory. Indeed, this device comprises four columns associated with four longitudinal and transverse uprights which are fixed in high position above the vehicle to be moved, and two longitudinal uprights which are in low position below the chassis of the vehicle to be carried. This device comprises vertical rails between the low longitudinal uprights and high longitudinal uprights. Levers can slide in the rails to lift the vehicle, and lifting is done by winding a cable.

Unfortunately, the traction system of this vehicle requires physical grooves or guides on the ground, which represents a higher investment cost and low flexibility if one wishes to change the configuration of the parking lot.

In addition, this device allows for a cross over of vehicles only in the longitudinal direction and its movement requires wheels which are specific to the grooves on the ground.

In addition, the device of U.S. Pat. No. 2,904,200 can only be operated manually and slowly, which reduces its effectiveness.

Thus, a first objective of the invention is to provide a more manageable device for moving vehicles in a parking area while limiting the adaptations of the parking area.

A second objective is to provide a better traction system and optimize the movement of the conveying device compared to the prior art.

A third objective is to provide better vehicle gripping means compared to the prior art.

To achieve these objectives, the invention provides a conveying device for moving and parking a vehicle, wherein the conveying device is movable and comprises at least one vehicle gripping means configured to be movable between a gripping position, in which said gripping means extends at least partially below the vehicle, and a release position in which said gripping means does not extend below the vehicle, said gripping means being configured to support the weight of the vehicle, characterized in that it comprises at least one computer associated with sensors, configured to control the movement of the conveying device as well as said gripping means.

Advantageously, this arrangement makes it possible to produce a robot device controlled by the computer.

According to one aspect, the conveying device comprises at least one column, and at least one longitudinal upright connected to said column, wherein said longitudinal upright is equipped with said gripping means, and said computer is further configured to control said longitudinal upright.

In particular, said longitudinal upright is movable between a low position in which said longitudinal upright allows said gripping means to be placed below the vehicle, and a high position in which said longitudinal upright is arranged above the height of the vehicle.

Advantageously, the conveying device does not require a fixed upright in the low position, which makes it possible to have room laterally at the bottom and to cross over vehicles on the side of the longitudinal upright. The conveying device is easy to handle because it allows for a cross over of vehicles sideways to pick up another vehicle. In addition, the device does not require significant modifications to the parking area in order to be functional.

According to other aspects, taken in isolation or combined in any technically feasible combination:
the conveying device comprises a traction system associated with multidirectional wheels, controlled by said computer; and/or
the size of the columns and/or uprights are adjustable; and/or
the conveying device further comprises at least one fixed upright carrying one or more of said movable uprights; and/or
said gripping means comprises independent articulated arms; and/or
said gripping means can vary its position along said longitudinal upright; and/or
said gripping means is configured to carry out a vehicle grip by the chassis, by the wheel treads or by a carrying platform; and/or
the conveying device comprises a lifting system and the lifting system comprises pivoting structures fixed to at least one upright; and/or
the conveying device comprises a lifting system and the lifting system comprises telescopic structures; and/or
the conveying device comprises a lifting system and the lifting system comprises lifting chains, jacks, ball screws and/or rack and pinion, and is associated with movable upright guides preferably arranged in the columns; and/or
the lifting system is integrated into the upright and the guides are integrated into the columns; and/or
the conveying device comprises a preferably robot handling/inspection arm; and/or
the conveying device is characterized by a centrally symmetrical structure, in particular for one or more of said gripping means, said upright, said column, said traction system, and/or said lifting system; and/or
the conveying device comprises reception and/or transmission antennas arranged in the diagonal extremes of the conveying device.

The invention further relates to a vehicle movement and parking system, comprising at least two conveying devices according to the invention, controlled in tandem.

Another object of the invention relates to a vehicle moving and parking method, comprising vehicle gripping, moving and parking steps by means of at least one conveying device according to the invention, or a moving and parking system according to the invention.

In particular, the method is carried out by means of a moving and parking system according to the invention, for at least one obstructed vehicle whose access is blocked by at least one obstructing vehicle, and the method comprises steps for handling said obstructing vehicle, handling said obstructed vehicle, moving said obstructing vehicle, moving said obstructed vehicle, relocating said obstructing vehicle, and putting down said obstructed vehicle.

Preferably, the method is carried out with at least two conveying devices, and is characterized by steps of controlling said devices in tandem.

The invention further relates to a computer program comprising program code instructions for executing the steps of a method according to the invention or the steps for implementing a conveying device according to the invention, when said program runs on a computer.

The invention will be further disclosed in detail by describing non-limiting embodiments, and on the basis of the appended figures illustrating variants of the invention, in which:

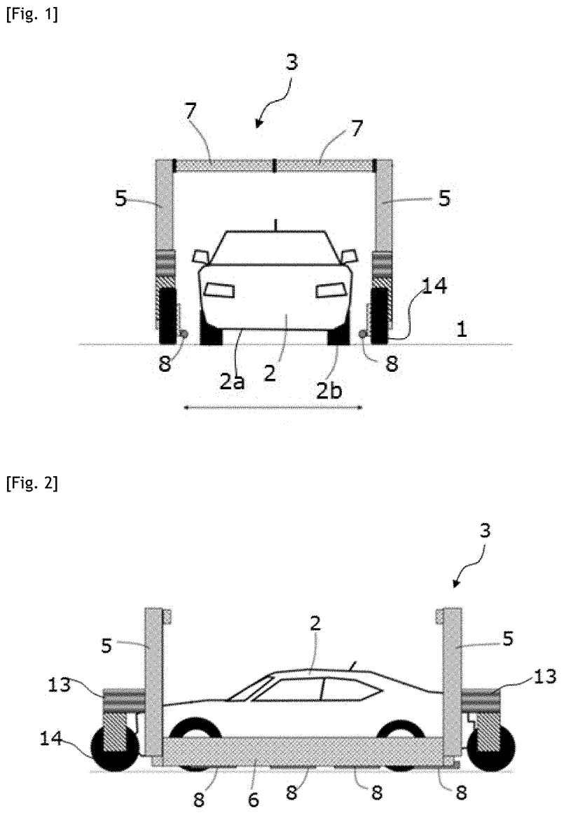

FIG. 1 schematically illustrates a front view of a conveying device according to a first preferred embodiment of the invention;

FIG. 2 schematically illustrates a side view of the conveying device according to the first embodiment;

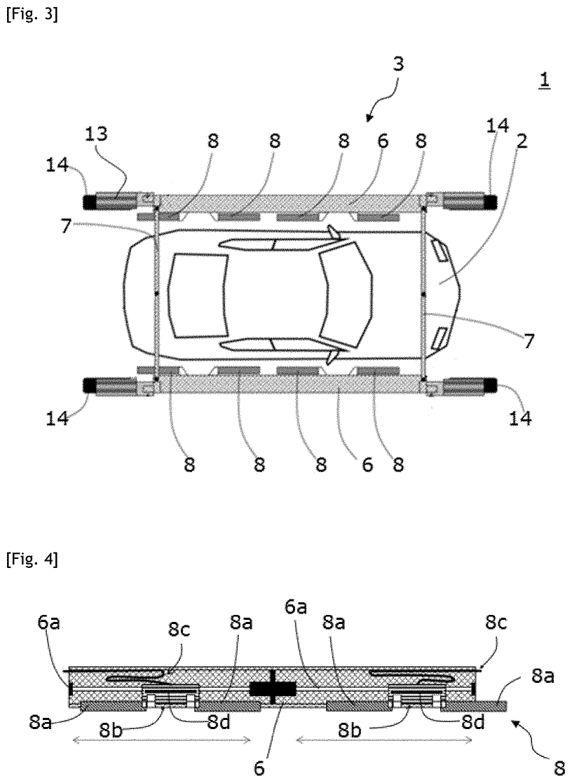

FIG. 3 schematically illustrates a top view of the conveying device according to the first embodiment;

FIG. 4 schematically illustrates gripping means of a longitudinal upright of the conveying device according to the first embodiment;

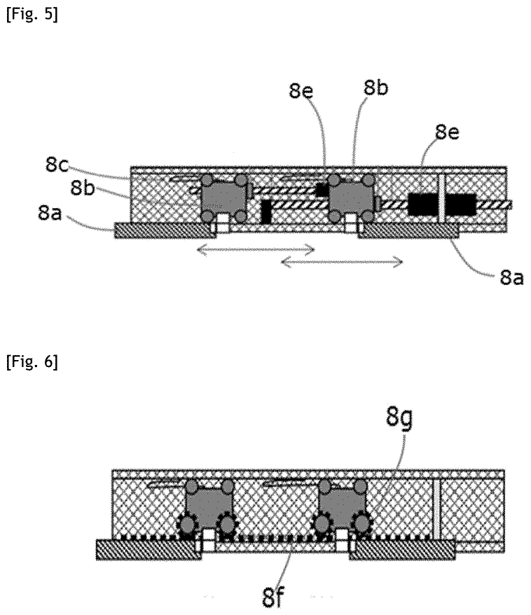

FIG. 5 schematically illustrates another variant of gripping means;

FIG. 6 schematically illustrates another variant of gripping means;

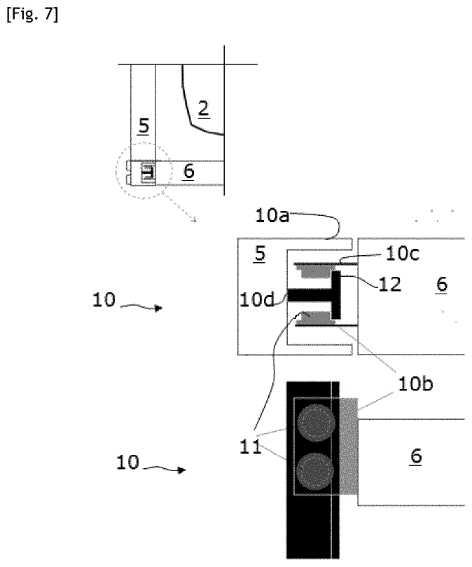

FIG. 7 schematically illustrates a lifting system of the conveying device according to the first embodiment;

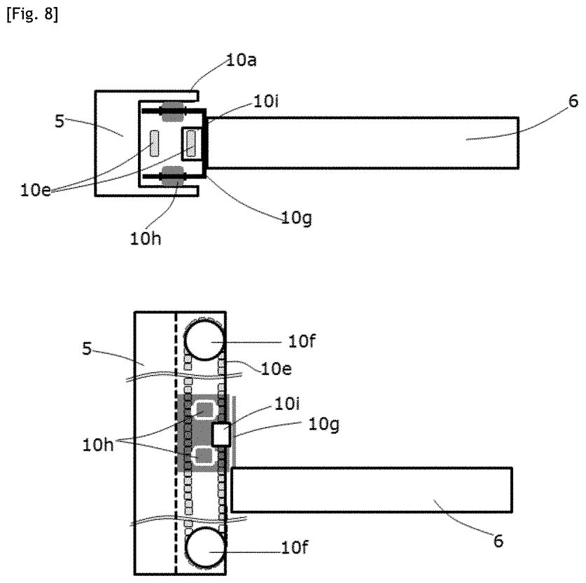

FIG. 8 schematically illustrates another variant of the lifting system with

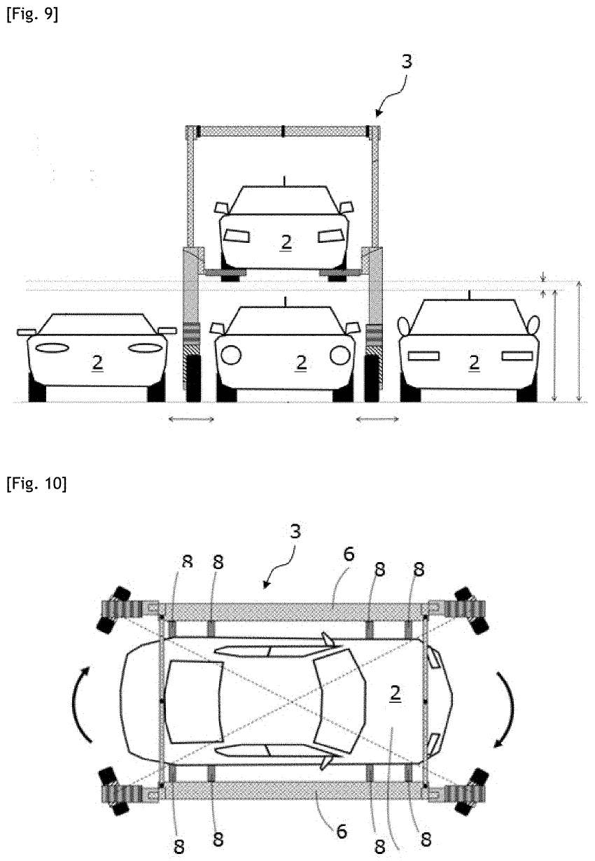

FIG. 9 schematically illustrates the conveying device according to the first

FIG. 10 schematically illustrates the possibilities of pivoting the conveying device according to the first embodiment;

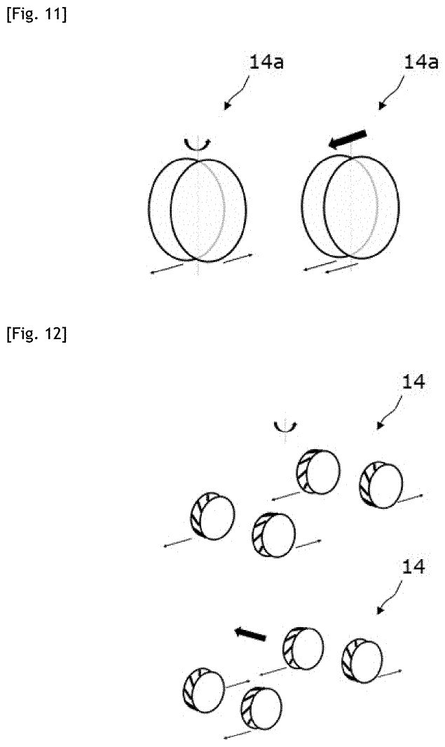

FIG. 11 schematically illustrates the operation of multidirectional wheels in a variant of the conveying device according to the invention;

FIG. 12 schematically illustrates the operation of wheels of the type

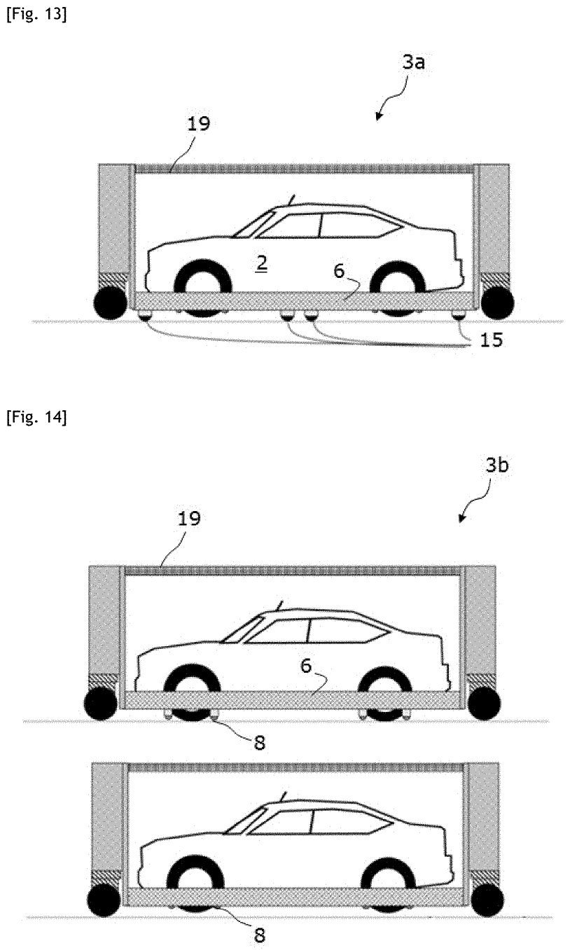

FIG. 13 schematically illustrates a conveying device according to a second embodiment having a side frame different from that of the first embodiment as well as additional wheels;

FIG. 14 schematically illustrates a conveying device according to a third embodiment having a side frame similar to that of the second embodiment and different from that of the first embodiment, and allowing for a lift of the gripping means;

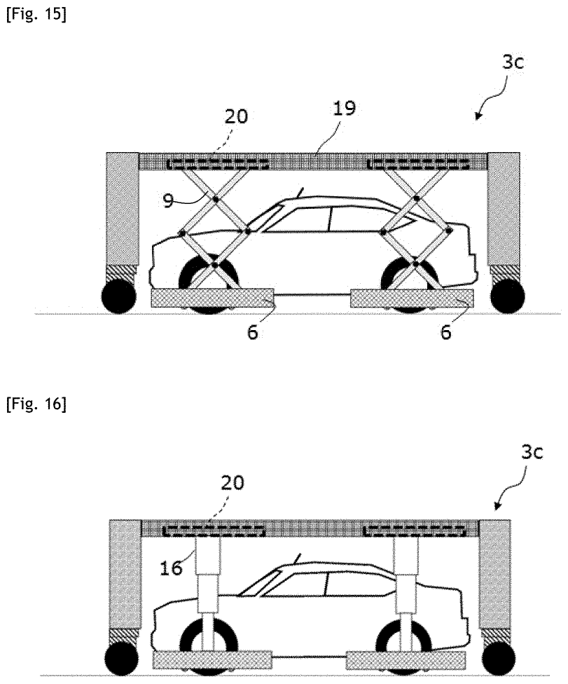

FIG. 15 schematically illustrates a conveying device according to a fourth embodiment having a side frame different from those of the first three embodiments;

FIG. 16 schematically illustrates a variant of the conveying device according to the fourth embodiment;

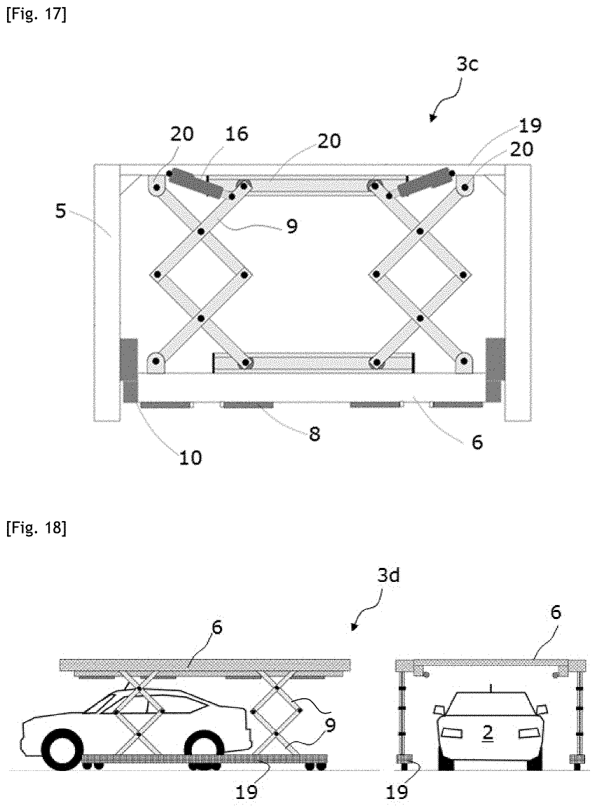

FIG. 17 schematically illustrates part of another variant of the conveying device according to the fourth embodiment;

FIG. 18 schematically illustrates a conveying device according to a fifth embodiment having a side frame different from those of the first four embodiments;

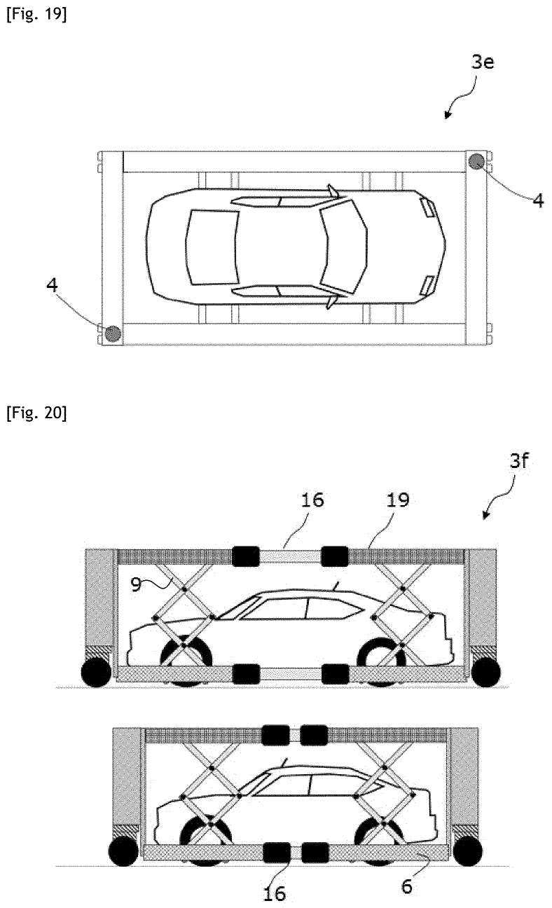

FIG. 19 schematically illustrates a conveying device according to a sixth embodiment associated with detection means;

FIG. 20 schematically illustrates side views of a conveying device according to a seventh embodiment having longitudinal uprights adjustable in size;

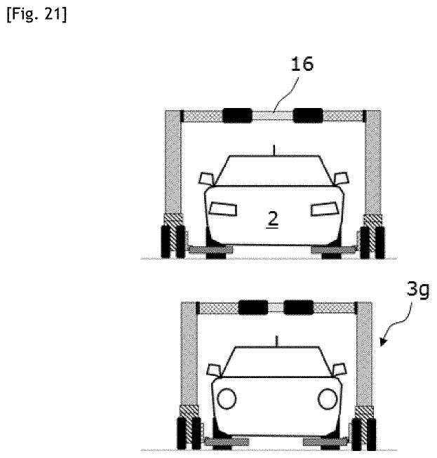

FIG. 21 schematically illustrates front views of a conveying device according to an eighth embodiment having transverse uprights adjustable in size;

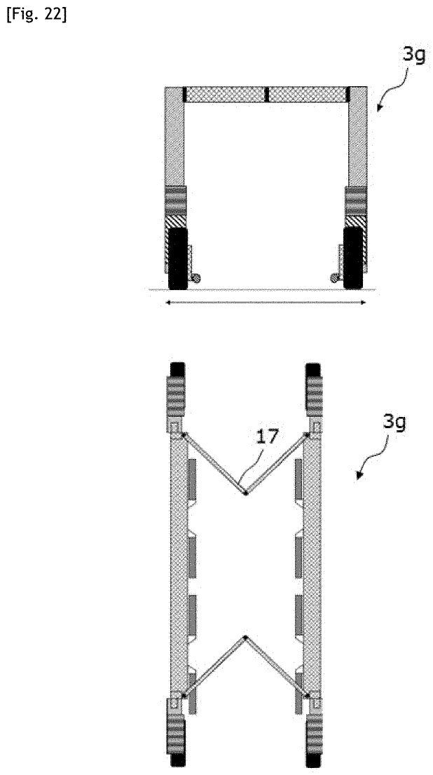

FIG. 22 schematically illustrates a top view of an alternative variant of the eighth embodiment;

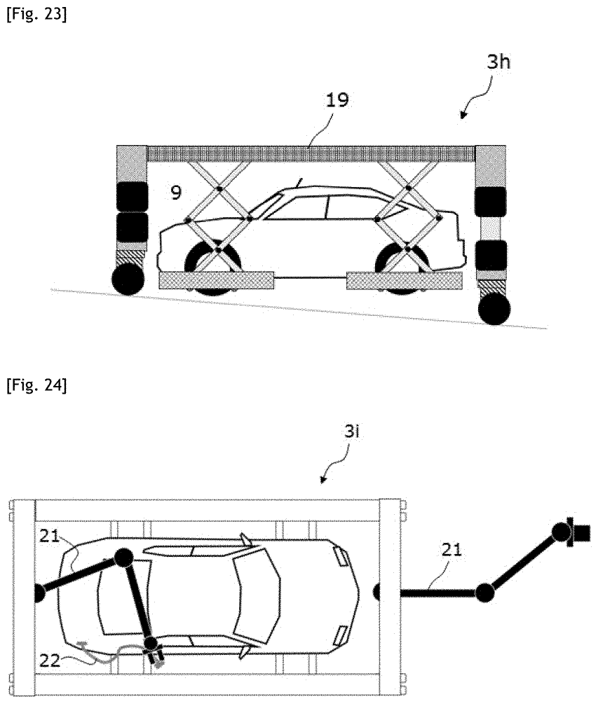

FIG. 23 schematically illustrates a conveying device according to a ninth embodiment having height adjustable columns;

FIG. 24 schematically illustrates a conveying device according to a tenth embodiment having two handling/inspection arms;

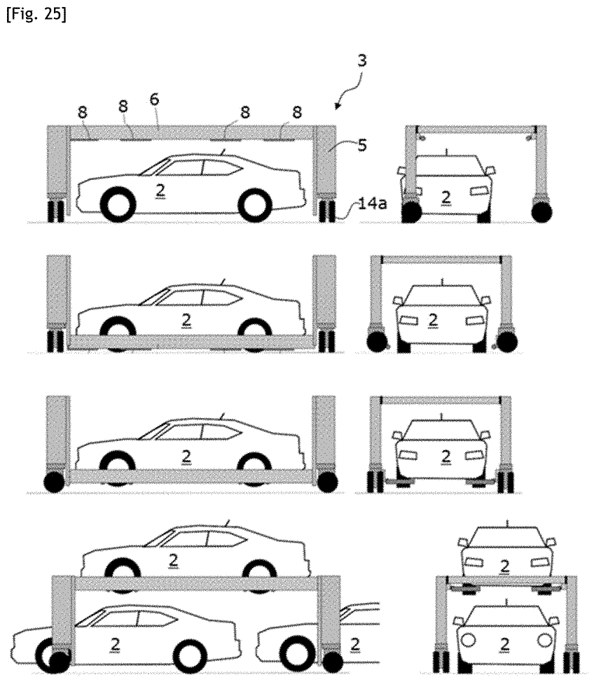

FIG. 25 schematically illustrates longitudinal and transverse crossover elements of a conveying device according to the first embodiment; and

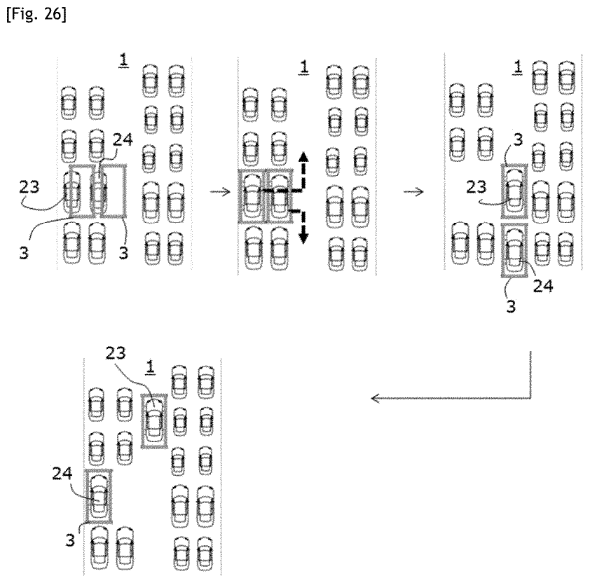

FIG. 26 schematically illustrates a method implementing at least two conveying devices according to the invention for an obstructed vehicle whose access is blocked by an obstructing vehicle.

The invention relates to the management of a parking area 1 (or parking lot) for vehicles 2, in particular motor vehicles such as cars. The invention relates to a conveying device 3 for moving and parking vehicles. The conveying device is in certain cases a crossover device. The conveying device 3 is movable on the parking area 1. It is in particular a robot type device equipped with sensors and/or other environmental sensing devices allowing to move it and to detect its environment and, more particularly, the objects, their relative positions and the edges of the vehicle 2 to be moved. Optical sensors and/or a radar system can be considered.

In particular, the conveying device 3 comprises at least one computer and distance sensors, in particular at least one passive optical sensor (camera(s)), at least one active optical-type sensor (LIDAR), one radar-type and/or acoustic-type sensor. Advantageously, this aspect makes it possible to carry out faster and more secure operations, also allowing automated applications.

More particularly, the conveying device 3 comprises at least one computer and a radio frequency positioning device, in particular of the GNSS type (or an indoor RF positioning device such as, for example, of the UWB type) allowing for a measurement of positions and heading. Advantageously, this allows use in a context of low visibility for the operator and/or perception of the sensors. This can be practical in an outdoor environment.

More particularly, the conveying device 3e comprises reception and/or transmission antennas 4 for positioning by radio frequency, in particular of the GNSS or UWB type, placed in the diagonal ends of the device. This variant may be illustrated by FIG. 19. Obviously, the variants of the figures may be combined in any technically feasible combination. Advantageously, this antenna positioning allows for a maximization of the reception and/or transmission field of the antennas 4, in particular when the vehicle 2 is in a high position. This increases the availability, reliability and accuracy of position measurements. This positioning also maximizes the distance between the two antennas, an aspect which improves heading measurement.

According to a variant, in addition to the computer, the conveying device also comprises encoders allowing navigation by odometry. Advantageously, this allows use in a context of low visibility and for an improvement of the precision of position and heading knowledge. It is possible to consider a variant with, in addition, an inertial measurement unit (IMU). It increases the reliability and availability of position and heading knowledge in the event of a transient loss of other environmentally sensitive sensors (especially RF and optical).

According to a variant, in addition to the computer, the conveying device also includes a wireless communication device (in particular in RF) allowing the command and bidirectional exchange of remote data. Advantageously, this allows remote manual or automatic control or monitoring and the reception of positioning corrections by RF (in particular differential GNSS or RTK).

Furthermore, the conveying device may include at least one communication device allowing, in particular, the wireless sending of data and commands

The conveying device 3 may be fully automatic and controlled by a robot. Alternatively, or in combination, the conveying device may be semi-automatic, i.e., to be partially controlled by a human operator. Alternatively, or in combination, full manual control may be considered, although this variant is not preferred.

Now concerning the structure of the conveying device 3, it preferably has a central symmetry, which makes it possible to facilitate manufacture by producing the same part several times. In particular, the lateral sides consist of two generally identical frames.

The conveying device 3 comprises columns 5. These are, in particular, pillars supporting the general structure of the conveying device 3. More particularly, there are four columns 5 distributed along prism heights, preferably parallelepiped. The columns 5 are configured to extend around the four corners of the vehicle 2 to be moved. The columns 5 are preferably generally identical.

In particular, the longitudinal and transverse distances between the columns 5 are greater than those of the vehicle 2 to be transported. This makes it possible to cross over. The conveying device 3 comprises at least one longitudinal upright 6 fixed to the columns 5. These are, in particular, two longitudinal uprights 6 in lateral position. In the preferred variant, the conveying device 3 further comprises at least one transverse upright 7, for example, two transverse uprights 7. The transverse upright 7 makes it possible to transfer torque as well as make actuations. In the preferred embodiments, the longitudinal uprights 6 and the transverse uprights 7 form a rectangular frame in top view.

The longitudinal upright 6 is equipped with at least one vehicle gripping means 8. In particular, this is a structure configured to grip the vehicle 2 in order to carry and move it. For example, the structure comprises pivotable gripping arms 8a. More particularly, the gripping means 8 is configured to carry out a gripping of the vehicle 2 either by the frame 2a, or by the wheel treads 2b of the vehicle 2, or by a carrying platform (not shown) on which the vehicle 2 is placed. Thus, the gripping means 8 is configured to at least partially support the weight of the vehicle 2 to be carried. In particular, the conveying device 3 comprises several gripping means 8 which, together, are configured to support the entire weight of the vehicle 2 to be carried.

Besides the gripping means 8, the corresponding longitudinal upright 6 is also configured to, at least partially, support the weight of the vehicle 2. In particular, the two longitudinal uprights 6 are configured to together support the entire weight of the vehicle 2 to be carried.

The gripping means 8 is configured to be movable between a gripping position, i.e., deployed, and a release position, i.e., folded up. In the gripping position, the gripping means 8 extends, at least partially, below the vehicle 2. For example, the gripping arms 8a are pivoted to be arranged below the vehicle. In particular, once in the gripping position, if the gripping means 8 is lifted, it allows the motor vehicle 2 to be carried. The gripping position can be illustrated by FIG. 10. In the release position, the gripping means 8 does not extend below the vehicle 2. For example, the gripping arms 8a are pivoted to be arranged at a certain distance from the vehicle 2. In particular, once in the release position, if the gripping means 8 is lifted, it rises next to the vehicle 2 without allowing the motor vehicle 2 to be carried. The release position can be illustrated by FIGS. 3 to 6.

Preferably, each gripping means 8 is independent of the others in their changes of position and/or configuration. In a variant detailed below, each gripping arm 8a can position itself and/or change its configuration (e.g., deployed, folded) independently of the other arms. Advantageously, this allows a faster and more robust grip of the wheels 2a compared to simultaneous actuation of a pair of arms. In addition, it allows a more effective grip with respect to the contact angles of wheels 2a of different diameters. In addition, independent gripping means 8 allow for a grip of the wheels 2a of cars 2 with different distances between axles. Furthermore, it allows overall centering of the car within the robot rectangle, as well as a reduction in the length of the uprights (and therefore the robot) required for all car sizes and associated axle positions.

According to one variant, moving means the gripping means 8 are arranged in the corresponding longitudinal upright 6. This is, for example, a motor, preferably individual motors, each associated with a transmission element such as a worm screw, chains, a rack and pinion system, ball screws. Advantageously, this makes it possible to simplify the lifting system, to cross over other vehicles 2 also by a lateral movement without being hampered by the moving means. The longitudinal upright 6 has sufficient space for this purpose.

FIG. 4 shows an exemplary embodiment of the gripping means 8 and its moving means in the longitudinal upright 6. The arms 8a may be separated by a fixed distance. The longitudinal upright 6 comprises a horizontal linear positioning system 6a for positioning the gripping means 8. In the preferred variant, there is one per gripping means 8. In addition to the gripping arms 8a, the gripping means 8 comprises an articulated movable device 8b such as a trolley with at least one articulated arm 8a by movable device 8b. The gripping means 8 further comprises a channel or strand of cables 8c with one end for horizontal movement. Preferably, the gripping means 8 further comprises a proximity detection device 8d.

FIG. 5 shows another embodiment of the gripping means 8 and its moving system in the longitudinal upright 6. The arms 8a may be separated by a variable distance. The variable distance between the gripping arm 8a may be achieved by an actuator 8e connecting the two carrying trolleys 8b of an arm 8a, each, for example, as illustrated in FIG. 5, or by independent actuations between each trolley 8b and the upright 6. The type of actuator 8e may be a worm/ball screw, jacks, rack and pinion 8f, chain-driven motor, or a combination of at least two of these. The actuators 8e ensure the change of position and the securing of the trolleys 8b along the upright 6. Additional wheels 8g may be provided for guiding and transferring mechanical loads. FIG. 6 illustrates a rack variant 8f with a guide, preferably integral with the upright 6.

According to the invention, the longitudinal upright 6 is movable between a low position in which the longitudinal upright 6 makes it possible to arrange the corresponding gripping means 8 below the vehicle 2, and a high position in which the longitudinal upright 6 is arranged above the height of the vehicle 2. In particular, the gripping means 8 is also arranged above the height of the vehicle 2.

Advantageously, the conveying device 3 according to the invention makes it possible to have room laterally at the bottom when the longitudinal upright 6 is in the high position. Therefore, it is possible to cross over vehicles 2 laterally, unlike the solutions of the prior art. In addition, the conveying device 3 is easily maneuverable because it allows crossing over vehicles 2 laterally to pick up another vehicle. In addition, the conveying device 3 does not require significant modifications to the parking area 1.

In addition, this enables a transfer of the mechanical torque from the weight of the vehicle 2 to the main structure of the conveying device 3 more efficiently.

Preferably, the longitudinal upright 6 is further movable in one or more intermediate positions between the low position and the high position. This makes it possible to use the conveying device 3 in parking areas 1 with a low ceiling height.

Now, concerning the lifting system of the conveying device 3 which makes it possible to lift the carried vehicle, it may include pinions and racks associated with a lifting actuator. It may include one or more lifting jacks with telescopic arms, as detailed below. Chains or lifting cables, preferably loop type, or vertical ball screws are also possible variants.

In a variant, the lifting system comprises pivoting structures 9, for example levers in scissor structures, fixed to the longitudinal uprights in another embodiment such as that of FIG. 15.

According to the preferred variant, at least one column 5 comprises at least one movement guide 10 for the movements of the movable uprights 6. This is, for example, at least one female structure 10a cooperating with at least one male structure 10b, preferably with bearings 11 (or rollers).

In particular, column 5 comprises a concave primary female structure 10a, for example in the shape of a “C” or “U”; and the upright 6 comprises the primary male structure 10b housed in the primary female structure 10a.

In addition, the primary male structure 10b comprises a secondary female structure 10c in the form of side panels forming a bearing support associated with bearings 11; and the primary female structure 10a comprises a secondary male structure 10d with transverse protuberances 12, for example in the shape of a “T,” cooperating with the bearings 11.

Advantageously, these guides 10 make it possible to constrain the vertical movement of the uprights 6 and thus the effective transfer of mechanical loads directly between the upright 6 and the columns 5. This is, in particular, advantageous for transferring loads of the longitudinal and lateral force types and the torque along the longitudinal axis. The guides 10, positioned near the columns 5, make it possible to free up the space between columns 5 and allow for crossover between them when the upright 6 is in the upper position.

These guides 10 in the low position also make it possible to reduce the load levels between the columns 10 and the uprights (upper 19), an aspect which makes it possible to reduce the structural sections then the sizes of the device and/or to increase the useful height of the portal frames (device height). Indeed, the loads supported by the bearings make it possible to relieve the forces in the upper zone. This reduces the tendency of the columns to open due to the weight of the vehicle 2.

In a variant such as that illustrated in FIG. 8, it is possible to use lifting chains 10e with corresponding upper and lower pulleys 10f. A pulley 10f, for example the upper one, may be associated with a motor. The movable upright 6 then comprises a mounting support 10g which may be equipped with rolling or sliding means such as at least one roller(s) 10h to be guided by a guide structure 10a of the column 5. The support 10g may be equipped with a fixing structure 10i to be fixed to the lifting chain 10e.

According to a variant, the movable upright 6 of the conveying device 3b comprises its own lifting device for lifting the gripping means 8. This lifting device makes it possible to lift the vehicles even when the movable upright is in the low position. This aspect can be illustrated by FIG. 14. This own lifting device may include a system of jacks. Advantageously, this aspect makes it possible to simplify the lifting system, in particular for applications with movements with little separation from the ground, such as, for example, parking garages with low ceilings.

Preferably, the lifting system comprises a locking mechanism allowing the positioning of the movable longitudinal uprights 6 at different heights and thus allowing the transport of the vehicles 2 at different distances from the ground.

Now, regarding traction, according to one variant, the conveying device 3 comprises a traction system 13 associated with main wheels 14, preferably multidirectional. These are, in particular, at least four wheels 14 arranged in line with or near the columns 5.

Preferably, at least one steering motor is provided per column 5 which does not participate in traction. This is because this motor changes the orientation of the main traction wheel, but does not inject energy directly into the traction action. This may be implemented, for example, by pinions associated with a ring gear and a rack, or by jacks.

In a variant, at least two wheels 14a are provided per column, each wheel being provided with an individual motor allowing it to participate in the traction. For example, it is a hub motor integrated directly around the axis of the wheel. FIG. 11 illustrates the overall movement of the wheels of a column (top arrow) according to the direction of rotation of the side wheel motors 14a (bottom arrows). Advantageously, this makes it possible to reduce the footprint of the wheels in order to gain in parking density.

In addition, the proposed traction systems also allow for rapid rotations and travel direction changes and to minimize the radius of curvature.

In particular, at least one of said main wheels 14 provided per column is of the “Mecanum” type. These are motorized wheels equipped with casters at the periphery. FIG. 12 illustrates the overall movement of the wheels of the conveying device 3, for wheels 14 of that type. The advantages explained above are amplified by the use of “Mecanum”-type wheels because there is no need to pivot the wheel 14: the direction, translation and/or rotation are defined by the combination of the movements of all of the wheels 14a of the conveying device 3. The use of the “Mecanum” wheels 14 also makes it possible to reduce the number of motors participating in the traction function and steering control.

The traction system may also be arranged next to the column 5, as can be seen in FIG. 2.

In one embodiment, the longitudinal 6 and/or transverse 7 uprights of the conveying device 3a comprise secondary wheels 15. This embodiment can be illustrated by FIG. 13. Advantageously, for movements under load at a low height from the ground (for example, for applications with low ceiling height), the secondary wheels 15 of the uprights 6 participating in the gripping of the vehicle 2 make it possible to transmit and reduce the mechanical loads to be supported by the main structure and the lifting system. This arrangement advantageously allows for reduction of the section size of the columns 5, uprights 6 and the lifting system, an aspect which allows for a reduction in the footprint of the conveying device 3 and an increase in the parking density.

According to one embodiment, the size of the longitudinal upright 6 is adjustable. Thus, the longitudinal distance between the main columns 5 may be varied by the longitudinal uprights 6 provided, for example, with a telescopic device 16. The longitudinal uprights 6 may be fixed and/or movable, i.e., the setting is fixed or adjustable during operation. This is also the case for the fixed longitudinal uprights 19, where applicable. Advantageously, this makes it possible to optimize the space provided for each parked car, not to be limited by the wide variety of lengths between the car models, and to optimize the size of the conveying device 3f for its transport. This aspect can be illustrated by FIG. 20.

According to one embodiment, the size of the transverse upright 7 is adjustable.

Thus, the lateral distance between the main columns 5 is variable by transverse uprights, provided, for example, with a linear telescopic device 16 or a foldable device 17. The transverse uprights 7 may be fixed and/or movable, i.e., the setting is fixed or adjustable during operation.

Advantageously, this makes it possible to optimize the space provided for each parked car in order to increase the overall density (cars per m2) of the parking garage, and not to be limited by the wide variety of widths between the car models. This also allows the size of the 3g conveying device to be optimized for its transport. This aspect can be illustrated by FIG. 21 for the linear telescopic device 16, or by FIG. 22 for the foldable device 17.

According to one embodiment, the size of column 5 is adjustable. In particular, the height of the columns 5 is variable by telescopic devices 16. Advantageously, this makes it possible to optimize the size of the conveying device 3h for its transport, to optimize the size for accessing spaces at reduced height and to level the vehicle 2 while moving in relation to a sloping ground. This aspect can be illustrated by FIG. 23.

According to one embodiment, the conveying device 3c or 3d further comprises at least one fixed upright 19 carrying one or more of said movable uprights 6. This variant can be illustrated by FIGS. 17 and 18. FIG. 17 only illustrates the relevant part of the conveying device for simplicity of illustration. In particular, the conveying device 3c or 3d comprises in each side frame, at least one fixed longitudinal upright 19 and at least one movable longitudinal upright 6 connected to each other for example by a telescopic system 16 and/or a system of scissor levers 9. A telescopic system 16 associated with the fixed upright 19 makes it possible to be used as a “passive” mechanical guide, as illustrated in FIG. 17. Consequently, the guides 10 are not necessary in the columns 5. The embodiment of FIG. 18 has a lower fixed upright 19 and a moving upright 6 which rises.

In addition, the lifting actuator may be integrated into this telescopic structure (e.g., a vertical jack parallel to the telescopic segments, or a jack between two rotating segments of the scissors, or angular actuators between two rotating segments of the scissors, etc.).

A telescopic system between the two types of uprights 6, 19 allows, for example, for a simplification of the columns, and even for a removal of them, as can be seen in FIG. 18.

Furthermore, a scissor-like structure in its folded configuration is one of the most compact. When the fixed upright 19 is high, this makes it possible, among other advantages, to maximize the useful lifting height for a given total height of the conveying device 3. This feature is particularly useful for applications with low ceiling height and/or the need to cross over with lateral movements. In addition, this makes it possible to facilitate the transport of the conveying device 3 (smaller size). The scissor-like structure also makes it possible to multiply the stroke of a jack participating as a lifting actuator. This aspect is particularly useful in the case of electric jacks with low stroke speed.

Preferably, the movable uprights 6 may each have a base 20 in the fixed upright 19, and each base 20 is movable independently of the other in the fixed upright 19. Thus, all the vehicle grips can vary their position along the length of the fixed upright 19. This advantageously makes it possible to have a grip centered along the conveying device 3 for the different wheelbases and lengths of vehicles, which makes it possible to reduce the size of the device. This reduces its footprint, and allows for an increase of the parking density, a reduction of the manufacturing cost, the size of structural sections and a facilitation of its transport.

According to one variant, the conveying device 3i further comprises at least one articulated or robot handling arm 21 on its frame. The handling arm 21 is preferably arranged on a transverse upright 7, more preferably in the middle thereof. It is also possible to consider placing said arm 21 on at least one column 5 and/or at least one longitudinal upright 6, 19. It may have a fixed or variable position.

The handling arm 21 is configured to allow handling and carrying of various objects 22 such as cables and electrical charging sockets for cars, cameras or other type of inspection devices and fire extinguishers. When the arm has a camera or other type of inspection device, it can be called an inspection arm 21. Thus, the invention further relates to a parking device comprising said handling/inspection arm 21.

Advantageously, the handling arm 21 allows the disconnection, carrying and/or connection of the recharging cables of electric cars between two parking places. This can be done on the car side and/or on the charging station side to manage different formats and locations of charging sockets.

In addition, the inspection arm 21 allows more efficient inspection of the interior (people or forgotten objects) and exterior (damage, fire) of vehicles and the parking lot as a whole.

Furthermore, the handling arm 21 can allow the removal of objects or obstacles in the path of the conveying device 3i such as branches, debris and snow.

In addition, the handling arm 21 may allow the effective action of a fire extinguisher without endangering the intervention of a person in the event of a fire in a parking lot.

The handling arm 21 may allow intervention on the devices and vehicles, i.e., unlock a mechanism, tow the vehicle.

The invention further relates to a system for moving and parking vehicles, comprising at least two conveying devices 3 as described above, controlled in tandem. For example, the same robot control is performed on the conveying devices 3, to perform additional grips and movements.

This makes it possible to implement selective access to any positions in the parking area at the same time.

Another object of the invention relates to a method for moving and parking vehicles, comprising steps for picking up, moving and parking vehicle 2 by means of at least one conveying device 3 as described above, or a moving and parking system as described above.

This is, in particular, a control method comprising crossover steps, including lateral, and/or comprising steps of controlling robots in tandem.

The longitudinal and transverse distances between the main columns 5 being sufficient, the conveying device 3 can easily crossover in the front/rear direction, and also in a lateral direction. This can be illustrated in FIG. 25. Advantageously, this makes it possible to access a parking space from the sides without the need for an access path.

In particular, generally simultaneously, the conveying devices 3 position themselves for the gripping and movement of several neighboring vehicles 2, taking advantage of the closest free lane in a group of vehicles 2.

More particularly, the method is carried out by means of a moving and parking system as described above, but it can be adapted for other types of vehicle parking devices. The method allows the movement and parking of at least one obstructed vehicle 23 to which access is blocked by at least one obstructing vehicle 24.

According to the invention, the method comprises steps for handling, in particular crossing over the obstructing vehicle 24, handling, in particular crossing over the obstructed vehicle 23, moving the obstructing vehicle 24, moving the obstructed vehicle 23, repositioning the obstructing vehicle 24, and putting down the obstructed vehicle 23. Depending on the number of vehicles 23, 24, the sufficient number of conveying devices controlled in tandem is provided.

Advantageously, this allows the rapid release of any vehicle 2 in a group without waiting for the serialization of several grips and individual movements as would be the case with devices without selective access. This process has a significant advantage for indoor parking lots where the ceiling height does not allow one car to be moved over others.

The invention further relates to a computer program comprising program code instructions for performing the steps of a method as described above, when said program is running on a computer.

The invention further relates to a computer program comprising program code instructions for the execution of the steps of implementing a conveying device as described above, in particular of the steps of controlling the elements of a conveying device as described above, when said program is running on a computer. Each movement or action of the conveying device or part of it can be considered as a computer-implemented process step.

Another object of the invention relates to a controlled system for moving and parking vehicles, such as an automatic or semi-automatic robot system.

The controlled system comprises a control unit in which a program as described above is loaded, as well as at least one conveying device as described above.

The control unit may be remote from the conveying device, for example in a control zone in the parking lot.

1. A conveying device for moving and parking a vehicle, the conveying device being movable and comprising at least one vehicle gripping means configured to be movable between a gripping position in which said gripping means extends at least partially below the vehicle, and a release position in which said gripping means does not extend below the vehicle, wherein said gripping means are configured to support the weight of the vehicle, characterized in that the device comprises at least one computer associated with sensors, configured to control the movement of the conveying device as well as said gripping means.

2. The conveying device according to claim 1, characterized in that it comprises at least one column, and at least one longitudinal upright connected to said column, said longitudinal upright being equipped with said gripping means, said computer being further configured to drive said longitudinal upright.

3. The conveying device according to claim 2, characterized in that said longitudinal upright is movable between a low position in which said longitudinal upright allows said gripping means to be placed below the vehicle, and a high position in which said longitudinal upright is arranged above the height of the vehicle.

4. The conveying device according to claim 1, characterized in that it comprises a traction system associated with multidirectional wheels, controlled by said computer.

5. The conveying device according to claim 2, characterized in that the size of the columns and/or uprights is adjustable.

6. The conveying device according to claim 2, characterized in that it comprises at least one fixed upright carrying one or more of said movable uprights.

7. The conveying device according to claim 1, characterized in that said gripping means comprises independent articulated arms.

8. The conveying device according to claim 2, characterized in that said gripping means can vary its position along said longitudinal upright.

9. The conveying device according to claim 1, characterized in that said gripping means is configured to grip a vehicle by the chassis, by the wheel treads or by a carrying platform.

10. The conveying device according to claim 2, comprising a lifting system characterized in that the lifting system comprises lifting chains, jacks, ball screws and/or rack and pinion, and is associated with movable upright guides, preferably arranged in the columns.

11. The conveying device according to claim 2, comprising a lifting system characterized in that the lifting system comprises pivoting structures fixed to at least one upright.

12. The conveying device according to claim 1, comprising a lifting system characterized in that the lifting system comprises telescopic structures.

13. The conveying device according to claim 1, characterized in that it comprises at least one, preferably robot, handling/inspection arm.

14. The conveying device according to claim 1, characterized by a centrally symmetrical structure, in particular for one or more of said gripping means, at least one upright, said column, said traction system, and/or said lifting system.

15. The conveying device according to claim 1, characterized in that it includes reception and/or transmission antennas arranged in diagonal ends of the conveying device.

16. A vehicle moving and parking system, comprising at least two conveying devices according to claim 1, controlled in tandem.

17. A method for moving and parking a vehicle, comprising steps of gripping, moving and parking the vehicle by means of at least one conveying device according to claim 1, or a moving and parking system according to claim.

18. The method for moving and parking a vehicle according to claim 17, carried out by means of a moving and parking system, for at least one obstructed vehicle whose access is blocked by at least one obstructing vehicle, characterized in that it includes steps for handling said obstructing vehicle, handling said obstructed vehicle, moving said obstructing vehicle, moving said obstructed vehicle, relocating said obstructing vehicle, and putting down said obstructed vehicle.

19. The method for moving and parking a vehicle according to claim 16, with at least two conveying devices, characterized by steps of controlling said devices in tandem.

20. A computer program comprising program code instructions for performing the steps of a method according to claim 17, when said program is running on a computer.
